(19) United States
(12) Patent Application Publication
(10) Pub. No.: US 2023/0019593 A1
(43) Pub. Date: Jan. 19, 2023

(54) METHODS AND SYSTEMS FOR UNDERWATER GEAR TRACKING

(71) Applicant: Ashored Inc., Debert (CA)

(72) Inventors: Aaron Stevenson, Debert (CA); Maxwell Poole, Central Chebogue (CA)

(21) Appl. No.: 17/955,254

(22) Filed: Sep. 28, 2022

Related U.S. Application Data
(63) Continuation of application No. 16/747,623, filed on Jan. 21, 2020.
(60) Provisional application No. 62/795,897, filed on Jan. 23, 2019.

(51) Int. Cl. G06Q 10/08; H04W 4/02; H04W 4/029

(52) U.S. Cl. CPC G06Q 10/087; H04W 4/027; H04W 4/029; H04W 4/80

(57) ABSTRACT

A method for underwater gear tracking includes receiving, by a reporting device on a vessel, from a tag associated with an item, a signal indicating the item is on the vessel. The method includes determining, by the reporting device, that the item is not on the vessel. The method includes recording, by the reporting device, information associated with the environment of the vessel at a time the reporting device determines that the item is not on the vessel, without input from an operator of the vessel. The method includes recording, by the reporting device, information associated with the environment of the vessel at a time the reporting device determines that the item is not on the vessel, without input from an operator of the vessel. The method includes providing, by the reporting device, the recorded information to a computing device.

### CROSS-REFERENCE TO RELATED APPLICATIONS

This application is a continuation of U.S. Nonprovisional patent application Ser. No. 16/747,623, filed on Jan. 21, 2020, entitled “Methods and Systems for Underwater Gear Tracking,” which application claims priority from U.S. Provisional Patent Application Ser. No. 62/795,897, filed on Jan. 23, 2019, entitled “Methods and Systems for Underwater Buoy Release,” all of which are hereby incorporated by reference.

### BACKGROUND

This disclosure relates to an underwater release mechanism, and in particular, to releasing a marker for an underwater item.

Buoys may be used to identify the location of submerged items or hazards. The buoy may be connected to a long line, e.g. a rope or chain. The line may interfere with marine life and passing vessels.

### BRIEF SUMMARY

In one aspect, a method for underwater gear tracking includes receiving, by a reporting device on a vessel, from a tag associated with an item, a signal indicating the item is on the vessel. The method includes determining, by the reporting device, that the item is not on the vessel. The method includes recording, by the reporting device, information associated with the environment of the vessel at a time the reporting device determines that the item is not on the vessel, without input from an operator of the vessel. The method includes recording, by the reporting device, information associated with the environment of the vessel at a time the reporting device determines that the item is not on the vessel, without input from an operator of the vessel. The method includes providing, by the reporting device, the recorded information to a computing device.

### BRIEF DESCRIPTION OF THE DRAWINGS

Certain objects, aspects, features, and advantages of the disclosure will become more apparent and better understood by referring to the following description taken in conjunction with the accompanying drawings, in which:

FIG. 1A is a perspective view of an embodiment of the release mechanism with the marker lowered;

FIG. 1B is a perspective view of the embodiment of FIG. 1A with the marker raised;

FIG. 2 is a perspective view of an embodiment of the release mechanism including a cage, a lid plate, and a marker;

FIG. 3 is a top perspective view of an embodiment of the release mechanism without a cage;

FIG. 4 is a bottom perspective view of the embodiment of FIG. 3 showing the t-bar;

FIG. 5 is a bottom view of the embodiment of FIG. 3 showing the t-bar in the locked position;

FIG. 6 is a bottom view of an embodiment of the pressure can;

FIG. 7 is a perspective view of the embodiment of FIG. 6 with the outer casing of the pressure can removed;

FIG. 8 depicts a block diagram of an embodiment of a network including a plurality of release mechanisms;

FIG. 9 depicts a block diagram of an embodiment of a wireless network including a release mechanism, reporting device, and data storage;

FIG. 10 depicts a block diagram of an embodiment of the release mechanism;

FIG. 11 depicts a block diagram of an embodiment of the reporting device; and

FIG. 12 is a flow diagram depicting an embodiment of a method 1200 for underwater gear tracking.

### DETAILED DESCRIPTION

Users may place an item underwater and then retrieve it at a later time. For example, a fisherman may place lobster or crab traps throughout the ocean and then retrieve the traps, hopefully catching some lobster or crab. Fishing is merely an example, the disclosed aspects of the disclosure may be used with other equipment, such as with testing equipment, monitoring equipment, sampling equipment, instruments, collection equipment, ocean clean up equipment, or the like, and in other environments, such as lakes, seas, rivers, etc.

A floating buoy or marker may be used to indicate the location of the item when the item is submerged underwater. The connection line between the marker and the item, however, may negatively affect marine life or get tangled up or cut by passing vessels. In an aspect of the disclosure, the marker is submerged with the item. The release of the marker may be initiated by a remotely transmitted signal, an internal time-clock backup, or manually. Once released, the marker rises to the surface, indicating the location of the item. A user may then retrieve the item.

The marker may be released by a release mechanism. The release mechanism may include a t-bar that is able to rotate between an unlocked position and a locked position. The t-bar couples with a slot. The slot is configured to receive the t-bar when the t-bar is the unlocked position and lock the t-bar when the t-bar is in the locked position. The t-bar is able to fit through the slot when the t-bar is in an unlocked position. The slot may be in a lid plate. In some embodiments, the lid plate may be separate from the item. In some embodiments, the lid plate may be integral with the item, such that the slot is in a portion of the item.

In some embodiments, the t-bar may be rotatable to an arming position. To complete arming, the t-bar may be rotated 90 degrees over the lid plate. When the t-bar is in the locked position, separation from the lid plate is restricted. The t-bar may be rotated another 90 degrees in the same direction, which realigns the t-bar with the slot in the lid plate, enabling separation and release of the marker from the lid plate. In some embodiments, the arming is done manually. In some embodiments, the arming is done via wireless communication. In some embodiments, the arming is done via a button or other arming mechanism.

In some embodiments, the marker is connected to the item via a line, such as a rope, cable, cord, or chain. In some embodiments, the marker is connected to the lid plate via a first line and the lid plate is connected to the item. In such embodiments, the lid plate may be connected to the item via the first line, a separate second line, clips, screws, nails, glue, welded, adhesive, etc. In some embodiments, the marker is connected to the release mechanism, which is connected to the lid plate or item via a line. In some embodiments, the line may be curled around the release mechanism. In some embodiments, the line may be enclosed or partially enclosed by a cage. The cage may protect the line from being tampered with, tangled, knotted, moved, or disturbed underwater or while on the vessel. In some embodiments, the cage may have a hole which allows the line to advance through when the marker is released.

In another aspect, there is an automated tracking and location aggregation system that is a system for underwater gear tracking. The system may include reporting devices onboard marine vessels and an online server or database for storage, analysis, and dissemination of information. In some embodiments, the system may include Radio Frequency Identification (RFID) system(s) and/or Global Positioning System(s) (GPS). An aspect of the disclosure includes enabling automatic scanning and recording the location of the gear at the time the gear is deposited into the ocean. In some embodiments, the RFID system(s) is coupled with GPS information to identify the gear and record its location at time of deposit into the ocean.

In some embodiments, an RFID tag is affixed to the item. The RFID tag may be affixed to the release mechanism, buoy, or item. The RFID tag may help with tracking the item. For example, a fisherman may have multiple traps that are to be dropped in various locations along his route. A release mechanism with an RFID tag may be coupled to each trap. A reporting device on the fisherman's vessel detects the RFID tags. The reporting device may detect when an RFID tag is no longer on the vessel and records a set of information. The set of information may include one or more of the following: which RFID tag left, the time of day, the location at time of deposit, weather conditions, vessel speed, water conditions, notes from the fisherman, etc. The set of information may be uploaded to a database or cloud server in real time and updated into a live global chart showing the most recent position of all scanned gear. The data from this database or cloud server may be requested by users via software that displays nearby items in geographical proximity to the requester at time of request. The requester may access the data via a mobile device, computer, the reporting device, or equipment on the marine vessel. The database or cloud server may be used by a single user or may be used by multiple users.

For example, a fisherman using the system may attach a release mechanism with RFID tag to a plurality of traps. The tagged traps may be stored on the deck of the marine vessel. The reporting device may be mounted on the deck of the vessel or may be portable, such that the fisherman may carry or move the reporting device. The reporting device detects each tagged trap on the deck. The fisherman may drop a first tagged trap in a first location. The reporting device detects that the first tagged trap is no longer on the deck. The reporting device may record that the first trap was dropped in the first location. The reporting device may record other data, such as weather conditions, water conditions, speed of the vessel, etc. The reporting device may record this information without input from the fisherman. In some embodiments, the reporting device records the information in response to an input from the fisherman. The fisherman may input additional data, such as observations or notes. The fisherman may continue on his route and drop a second tagged trap in a second location. The reporting device detects that the second tagged trap is no longer on the deck and records that the second trap was dropped in the second location.

The fisherman continues on his route, dropping additional tagged traps in additional locations. The reporting device may record the information in a global chart. In some embodiments, the global chart may indicate the location of tagged traps dropped only by the fisherman. In some embodiments, the global chart may indicate the location of tagged traps dropped by one or more fisherman so that the fisherman can see where other traps are located. This may aid the fisherman in avoiding dropping his trap too close to another fisherman's trap.

The fisherman returns to collect his traps. The fisherman may use the global chart to identify locations to travel to collect his traps. For example, the fisherman may travel to the first location to collect the first tagged trap. The fisherman causes a signal to be sent to the release mechanism, activating the release of the marker. The t-bar is caused to rotate from the locked position to the unlocked position. The marker rises to the surface and the fisherman is able to collect his trap. The reporting device detects that the first tagged trap is on the deck. The reporting device may update the global chart to show that the first tagged trap is no longer at the first location, but is on the deck (i.e. collected). The reporting device may record this information automatically without input from the fisherman. In some embodiments, the reporting device may record a set of information with input from the fisherman, including catch results.

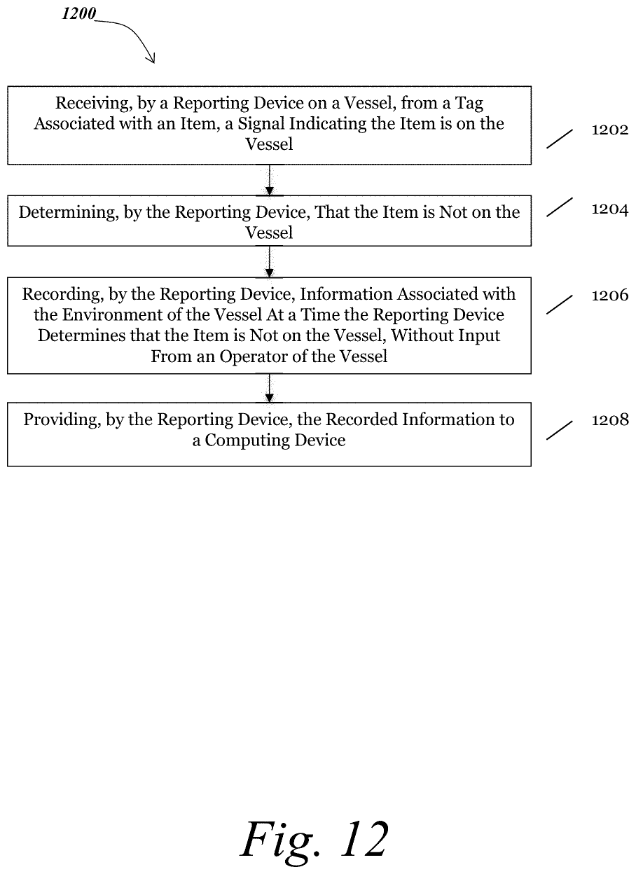

Therefore, the methods and systems described herein may provide functionality for underwater gear tracking. Referring ahead to FIG. 12, a flow diagram depicts an embodiment of a method 1200 for underwater gear tracking. As depicted in FIG. 12, in brief overview, the method 1200 includes receiving, by a reporting device on a vessel, from a tag associated with an item, a signal indicating the item is on the vessel (1202). The method 1200 includes determining, by the reporting device, that the item is not on the vessel (1204). The method 1200 includes recording, by the reporting device, information associated with the environment of the vessel at a time the reporting device determines that the item is not on the vessel, without input from an operator of the vessel (1206). The method 1200 includes providing, by the reporting device, the recorded information to a computing device (1208).

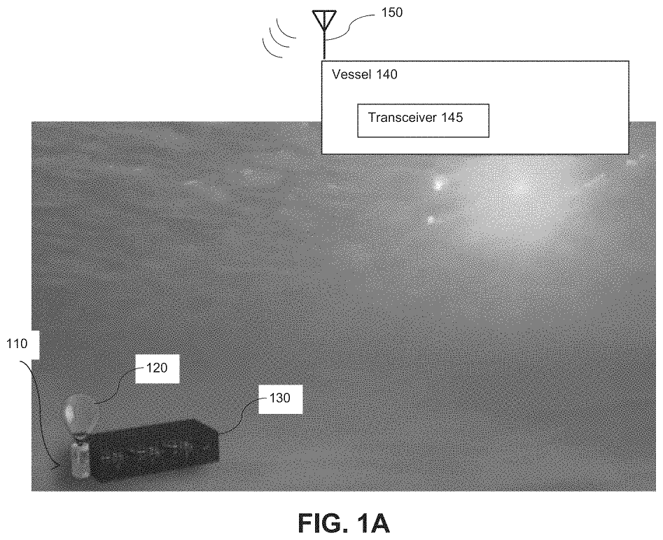

Referring to FIG. 12, in greater detail and in connection with FIGS. 1A-11, the method 1200 includes receiving, by a reporting device on a vessel, from a tag associated with an item, a signal indicating the item is on the vessel (1202). The item may be gear (e.g., fishing gear, scientific gear, or other gear designed to be used underwater). The tag may be a tag capable of communicating via RFID. The tag may be a tag capable of communicating via GPS. The tag may be a tag capable of communicating via other wireless communication protocols.

The method 1200 includes determining, by the reporting device, that the item is not on the vessel (1204). The reporting device may determine that the item is underwater.

The method 1200 includes recording, by the reporting device, information associated with the environment of the vessel at a time the reporting device determines that the item is not on the vessel, without input from an operator of the vessel (1206). The reporting device may record a unique identifier of the tag. The reporting device may record a time at which the signal from the tag was no longer detected by the reporting device. The reporting device may record a location at which the signal from the tag was no longer detected by the reporting device. The reporting device may record a speed of the vessel (e.g., at a time at which the signal from the tag was no longer detected by the reporting device).

The method 1200 includes providing, by the reporting device, the recorded information to a computing device (1208).

The method 1200 may further include arriving, by the vessel, at a location recorded in the information associated with the environment of the vessel at the time the reporting device determines that the item is not on the vessel; transmitting a signal to a release mechanism of the item to activate a release of a marker associated with the item, allowing the marker to rise to a surface of a body of water; determining, by the reporting device, that the item is on the vessel; and recording, by the reporting device, information indicating that the item is on the vessel.

In some instances, the tagged trap may have moved from the tagged location. For example, the second tagged trap may move away from the second tagged location so much so that the fisherman cannot activate the release of the marker. In some instances, the fisherman may not go to a location to activate the release of the marker. In some instances, an error may occur such that the release mechanism cannot be activated wirelessly. In such instances, it may be helpful that there is an internal time clock backup, which activates the release mechanism. The release mechanism is configured so that after a set time, if the release mechanism has not been activated, then the release mechanism activates, allowing the marker to rise to the surface. The fisherman may set the time via a button, t-bar, wirelessly, etc. In some embodiments, the time may be pre-set. In some embodiments, the time may be seconds, minutes, hours, days, weeks, months, or years, whichever is suitable for the circumstances. Once the marker is at the surface, the fisherman may collect the trap or another person traveling by may be able to collect the trap.

FIGS. 1A and 1B depict an embodiment of release mechanism 110 when it is underwater. The release mechanism no is connected to a marker 120 and an item 130. In some embodiments, the release mechanism no, marker, and item 130 may be located on the ocean floor. In some embodiments, the marker 120 is a buoy, flotation device, or object capable of floating in salt water and/or fresh water. A vessel 140 is in proximity with the release mechanism 110 such that the transceiver 145 and antenna 150 are able to communicate with the release mechanism 110.

In FIG. 1A, the release mechanism 110 and marker 120 are in a lowered position. The marker 120 is held underwater since it is connected to the release mechanism 110. After the release mechanism 110 receives a communication from the transceiver 145 and antenna 150, the release mechanism disengages from the item 130. In some embodiments, the release mechanism 110 may disengage from the item 130 after a set time. Once the release mechanism 110 disengages from the item 130, the marker 120 is able to rise to the surface, as shown in FIG. 1B. The marker 120 is connected to the item 130 via a line 125. The line 125 may be rope, cable, cord, chain, etc. As shown in FIG. 1B, the line 125 advances as the marker 120 rises towards the surface. Once the marker 120 nears the surface of the water, the marker 120 identifies the location of the underwater item 130. The item 130 can then be retrieved.

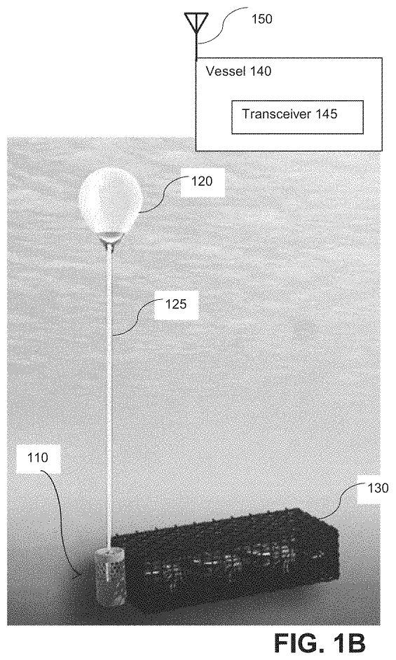

FIG. 2 depicts a perspective view of an embodiment of release mechanism 210, including an optional cage 270, floating underwater. The release mechanism 210 may include a marker 220, line 225, pressure can 265, and lid plate 260. The marker 220 is connected to the pressure can 265 which is coupled to the lid plate 260. The line 225 is wound around pressure can 265 and is at least partially enclosed by the cage 270 and lid plate 260. The cage 270 protects the line 225. The line 225 is connected to the pressure can 265 and lid plate 260.

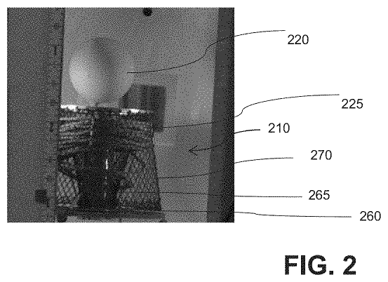

FIG. 3 depicts a top perspective view of an embodiment of release mechanism 310. In some embodiments, the release mechanism 310 may include a cage 270. The release mechanism 310 includes a pressure can 365 and lid plate 360. At one end, the pressure can 365 may include a connection ring 308, which is used to connect to a marker (not shown). At the other end, the pressure can 365 may include a t-bar 314. The pressure can 365 includes an outer casing 312. The pressure can 365 is sealed to protect the inner components when at underwater pressures. The outer casing 312 helps seal the pressure can 365. As shown, the pressure can 365 is generally cylindrical, however, the pressure can 365 may be a box or other shape and is not limited to a cylindrical shape.

As shown in FIG. 3, the lid plate 360 may be generally disc shaped. In other embodiments, the lid plate 360 may be square, triangular, oval, or other shape. The lid plate 360 may include one or more connection points 302, which may be used to connect the lid plate 360 to an item (not shown), pressure can 365, or marker (not shown). The lid plate 360 may include a horizontal surface and an outer edge. The connection point(s) 302 may be opening(s) through the outer edge of the lid plate 360. The lid plate 360 may include one or more openings 304 in the horizontal surface defined partially by arms 306. The openings 304 and arms 306 may be used to connect the lid plate 360 to the pressure can 365, marker (not shown), or item (not shown).

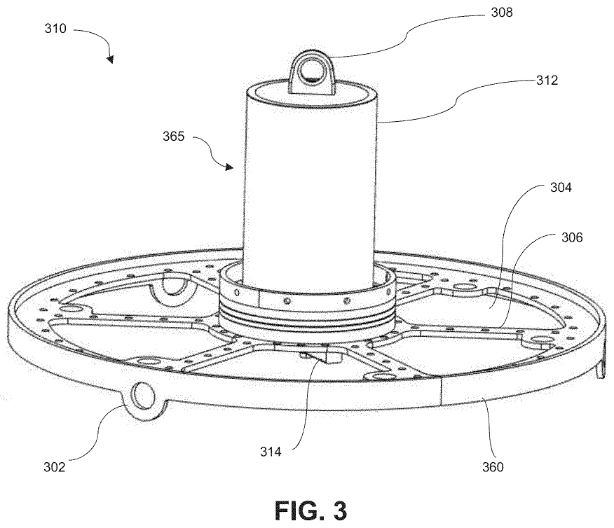

FIG. 4 shows a bottom perspective view of the embodiment of FIG. 3, with the t-bar 314 in a locked position. The pressure can 365 is coupled with the lid plate 360 via the t-bar 314 and slot 318. The slot 318 is an opening in the horizontal surface of the lid plate 360. The slot 301 is shaped to receive the t-bar 314 when the t-bar 314 is in the unlocked position.

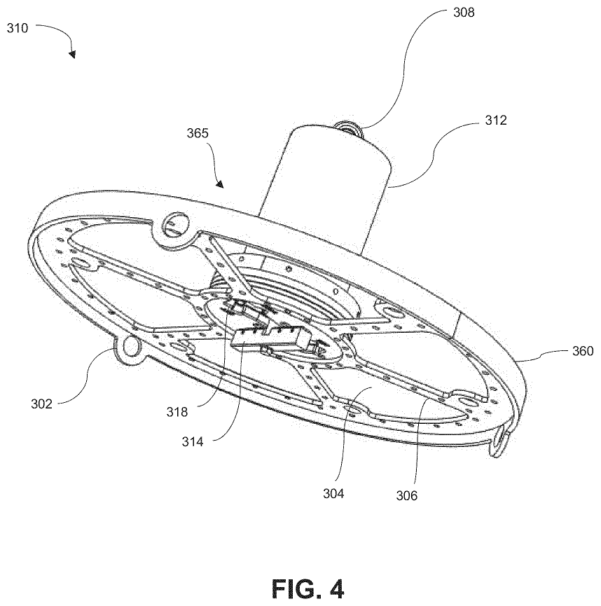

FIG. 5 shows a bottom view of the embodiment of FIG. 3, with the t-bar 314 in a locked position. When in the locked position, as shown, the t-bar 314 cannot pass through the slot 318 in the lid plate 360. The t-bar 314 may be rotated about 90 degrees to move from the locked position to the unlocked position. In some embodiments, the t-bar 314 may be rotated between 70 degrees and 110 degrees to move from the locked position to the unlocked position. The slot 318 is shaped to allow the t-bar 314 to pass through when the t-bar is in the unlocked position. The slot 318 may be shaped to receive pins 316. The pins 316 may restrict relative rotation between the pressure can 365 and the lid plate 360. In some embodiments, the pins 316 may couple with openings that are separate from the slot 318.

In some embodiments, the slot 318 may include portions to arm or set the release mechanism 310, as shown in FIG. 5. In some embodiments, the release mechanism 310 is armed and set manually by rotating the t-bar 314. In some embodiments, the release mechanism 310 is armed and set wirelessly.

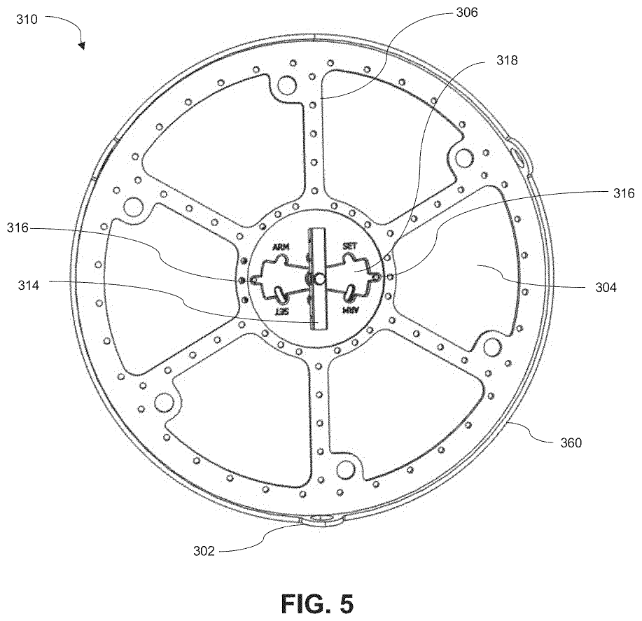

FIG. 6 shows a bottom view of the pressure can 365, with the t-bar 314 in the unlocked position. The t-bar 314 has been rotated about 90 degrees between the locked position in FIG. 5 and the unlocked position in FIG. 6. The pressure can 365 may include an end cap 322, pins 316, and optionally a window 324.

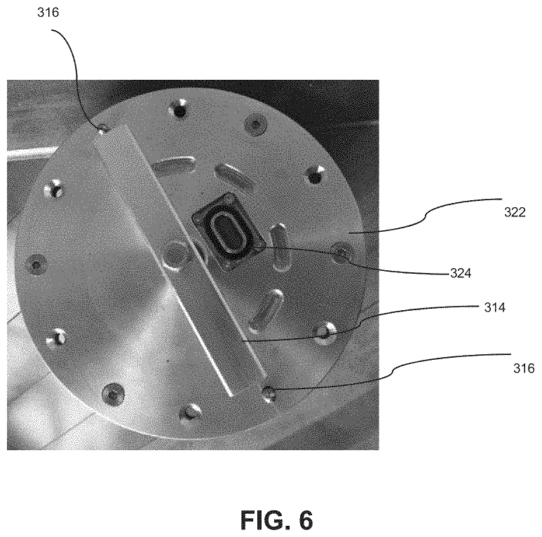

FIG. 7 is a perspective view of the pressure can 365 with the outer casing 312 removed to show the inner components, including a power source 326, a motor 328, gears 332, 334, and a magnet 338. The power source 326 may include batteries. The power source 326 is electrically connected via cables 327 to the motor 328 and processor (not shown). There is a 2× gear reduction via gears 332 and 334. The motor 328 is connected to the t-bar 314 and causes the t-bar to rotate about a longitudinal axis of the pressure can 365.

The motor 328 can be controlled by one or more controllers, which may include computer components such as one or more processors, memory or other storage media, network or other communication interfaces, and/or other circuitry. In some embodiments, a memory of the controller stores computer-executable instructions that, when executed by the processor and/or other circuitry of the controller, directly or indirectly cause the motor 328 to move in a predetermined sequence. The predetermined sequence can include, for example, rotating a set number of degrees. The set number of degrees may be between 70 and 110 degrees. The set number of degrees may be between 85 and 95 degrees. The set number of degrees may be 90 degrees.

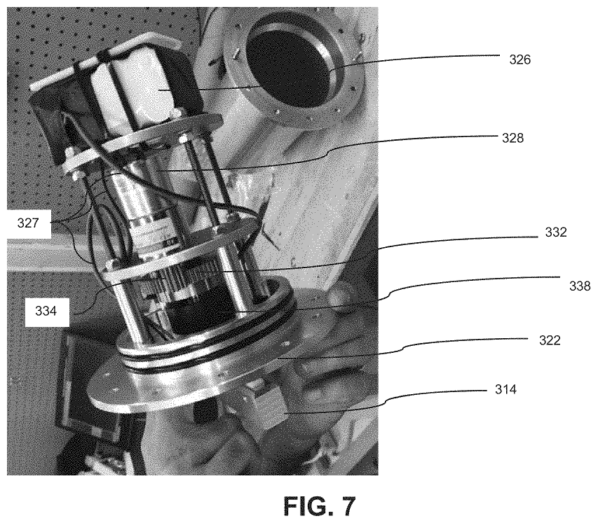

FIG. 8 depicts a diagram of an embodiment of a reporting device 875 and release mechanisms 810a, 810b, 810c, each with an RFID tag 815a, 815b, 815c. For example, the reporting device 875 and release mechanisms 810a-c may all be located on the deck of a vessel. The reporting device 875 may include an antenna 850 and transceiver 845. The RFID antenna 850 may generate a wireless field. The reporting device 875 detects which RFID tags 815a-c are present. For example, if release mechanism 810a was dropped overboard, the reporting device 875 would record that RFID tag 815a was no longer detected. The device 875 may include a GPS device or may communicate with a separate GPS to record the location at the time that the RFID tag 815a was no longer detected. The reporting device 875 may update a global chart, which indicates the locations of the release mechanisms 810a-c.

The wireless field 851 may represent the volume of space in which wireless power from the antenna 850 may be sourced to power the RFID tags 815a-c. The wireless field 851 also represents the volume of space in which the antenna 850 may detect the RFID tags 810a-110c and receive information from said RFID tags.

A wide variety of RFID tags are available. RFID tags may be programmed (written) and read by a suitably configured read/write device. Such RFID devices are useful for storing and retrieving desired application information such as unique identifier, RFID tag location, associated commands, associated devices, etc. In some embodiments, the RFID tag may be passive and require no batteries. In other embodiments, the RFID tag may be active and contain a battery. RFID tags are useful for electronically storing and retrieving desired user-specific or object-specific information.

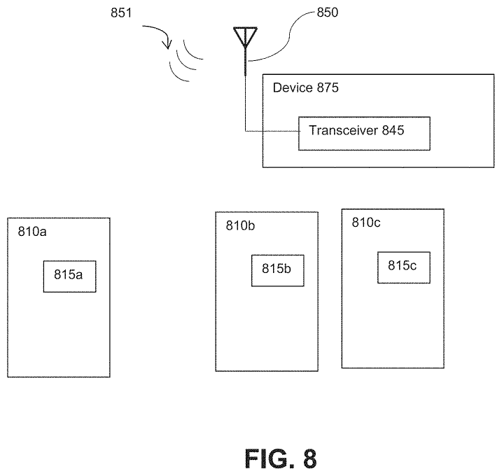

As shown in FIG. 9, the reporting device 875 may communicate with a network 890. The reporting device 875 may communicate to the network 890 a set of information. The information may include one or more of the following: which RFID tag was no longer detected, the location at the time, weather conditions, water conditions, speed of the vessel, notes, etc. The information is stored in data store 885.

The release mechanism 810 may connect to the network 890. Computing devices 880 may also connect to the network 890. A user may be able to view the global chart or information recorded by the reporting device 875 using a computing device 880, such as a phone, computer, or other device. When using the computing device 880 to access the network 890, the user may be on a vessel or may be on land.

In some embodiments, the network 890 may send an alert to the computing device 880 when the computing device 880 is near a location of a tagged release mechanism 810 stored in the database. In some embodiments, the network 890 may send an alert to the reporting device 875 when the reporting device 875 is near a location of a tagged release mechanism 810 stored in the database. The distance may be set by a user or may be preset. The distance may be measured in feet, meters, yards, nautical miles, miles, or other suitable measurement.

The connections to the network 890, as shown in FIG. 9, may represent any path or mode of communication, wired or wireless, through which data and/or commands may be communicated, for example, but not limited to, Bluetooth, Wi-Fi, Ethernet, near field communications (NFC), etc.

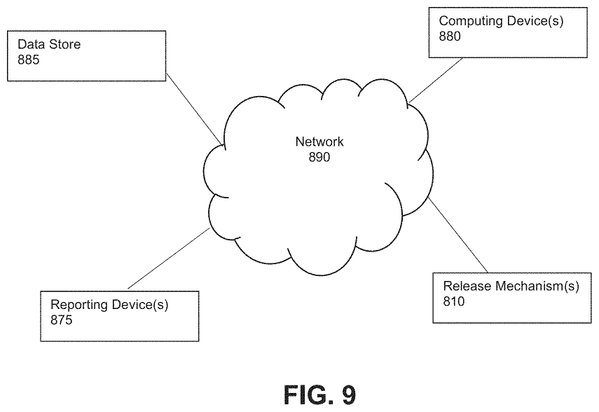

FIG. 10 depicts a block diagram of an embodiment of release mechanism 810. Release mechanism 810 includes a motor 828, power source 826, memory 842, processor/controller 844, RFID tag 815, and transceiver 846. The motor 828 is connected to power source 826 and processor/controller 844. The processor/controller 844 is connected to the power source 826, motor 828, transceiver 846, memory 842, and RFID tag 815. The processor/controller 844 is in communication with network 890. The processor/controller 844 may receiver a message from network 890 or through transceiver 846 to activate the release mechanism 810. The processor/controller 844 would communicate with the motor 828, which would cause the t-bar to rotate from a locked position to an unlocked position.

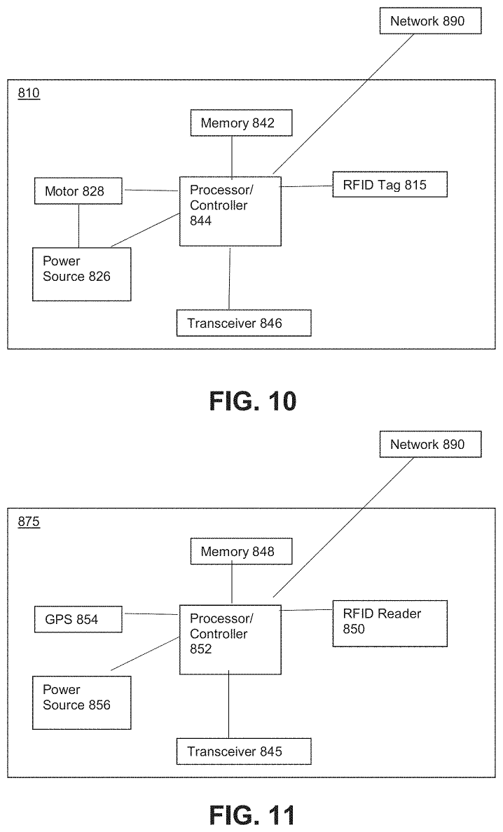

FIG. 11 depicts a block diagram of an embodiment of reporting device 875. The reporting device 875 includes a processor/controller 852, transceiver 845, memory 848, RFID reader 850, and optionally GPS 854 and power source 856. In some embodiments, the reporting device may communicate with an external GPS device and/or an external power source. The processor/controller 852 is in communication with network 890.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

The system may be used in connection with various operating systems such as Linux®, UNIX®, MacOS®, iOS®, Android® or Microsoft Windows®.

The system control may be written in any conventional programming language such as C, C++, BASIC, Pascal, .NET (e.g., C#), or Java, and ran under a conventional operating system. C, C++, BASIC, Pascal, Java, and FORTRAN are industry standard programming languages for which many commercial compilers may be used to create executable code. The system control may also be written using interpreted languages such as Perl, Python or Ruby. Other languages may also be used such as PHP, JavaScript, and the like.

As will be understood by those of skill in the art, in some embodiments, the processes set forth in the following material may be performed on a computer network. The computer network having a central server, the central server having a processor, data storage, such as databases and memories, and communications features to allow wired or wireless communication with various parts of the networks, including terminals and any other desired network access point or means.

As used herein, the terms “detect” or “detecting” encompass a wide variety of actions. For example, “detecting” may include calculating, computing, processing, deriving, generating, obtaining, looking up (e.g., looking up in a table, a database or another data structure), ascertaining and the like via a hardware element without user intervention. Also, “detecting” may include receiving (e.g., receiving information), accessing (e.g., accessing data in a memory) and the like via a hardware element without user intervention. Also, “detecting” may include resolving, selecting, choosing, establishing, and the like via a hardware element without user intervention.

As used herein, the term “message” encompasses a wide variety of formats for communicating (e.g., transmitting or receiving) information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

As used herein, “activate” or “activating” may refer to causing or triggering a mechanical, electronic, or electro-mechanical state change to a device. Activation of a device may cause the device, or a feature associated therewith, to change from a first state to a second state. Activating may include generating a control message indicating the desired state change and providing the control message to the device to cause the device to change state.

Any process descriptions or elements described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the computing system and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It is noted that some examples above may be described as a process, which is depicted as a flowchart, a flow diagram, a structure diagram, or a block diagram. Although a flowchart may describe the operations as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc. When a process corresponds to a software function, its termination corresponds to a return of the function to the calling function or the main function.

The above description discloses several methods and materials of the present disclosure. This disclosure is susceptible to modifications in the methods and materials, as well as alterations in the fabrication methods and equipment. Such modifications will become apparent to those skilled in the art from a consideration of this disclosure or practice of the disclosure disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A method for underwater gear tracking, the method comprising:
receiving, by a reporting device on a vessel, from a tag associated with an item, a signal indicating the item is on the vessel;
determining, by the reporting device, that the item is not on the vessel;
recording, by the reporting device, information associated with the environment of the vessel at a time the reporting device determines that the item is not on the vessel, without input from an operator of the vessel;
providing, by the reporting device, the recorded information to a computing device;
arriving, by the vessel, at a location recorded in the information associated with the environment of the vessel at the time the reporting device determines that the item is not on the vessel;
transmitting a signal to a release mechanism of the item to activate a release of a marker associated with the item, allowing the marker to rise to a surface of a body of water;
determining, by the reporting device, that the item is on the vessel; and
recording, by the reporting device, information indicating that the item is on the vessel.

2. The method of claim 1 wherein recording further comprises recording a unique identifier of the tag.

3. The method of claim 1 wherein recording further comprises recording a time at which the signal from the tag was no longer detected by the reporting device.

4. The method of claim 1 wherein recording further comprises recording a location at which the signal from the tag was no longer detected by the reporting device.

5. The method of claim 1 wherein recording, by the reporting device, information further comprises recording a speed of the vessel.

6. A computer readable medium having instructions thereon that when executed provide a method for underwater gear tracking, the computer readable medium comprising:
instructions to receive, by a reporting device on a vessel, from a tag associated with an item, a signal indicating the item is on the vessel;
instructions to determine, by the reporting device, that the item is not on the vessel;
instructions to record, by the reporting device, information associated with the environment of the vessel at a time the reporting device determines that the item is not on the vessel, without input from an operator of the vessel;
instructions to provide, by the reporting device, the recorded information to a computing device;
instructions to arrive, by the vessel, at a location recorded in the information associated with the environment of the vessel at the time the reporting device determines that the item is not on the vessel;
instructions to transmit a signal to a release mechanism of the item to activate a release of a marker associated with the item, allowing the marker to rise to a surface of a body of water;
instructions to determine, by the reporting device, that the item is on the vessel; and
instructions to record, by the reporting device, information indicating that the item is on the vessel.
